(19) United States
(12) Patent Application Publication
(10) Pub. No.: US 2009/0154035 A1
(43) Pub. Date: Jun. 18, 2009

(54) ESD Protection Circuit

(76) Inventors: Maurizio Galvano, Padova (IT); Giovanni Galli, Saonara (IT)

Correspondence Address: SLATER & MATSIL LLP, 17950 PRESTON ROAD, SUITE 1000, DALLAS, TX, 75252, US

(21) Appl. No.: 11/959,148

(22) Filed: Dec. 18, 2007

(51) Int. Cl. H02H 9/04

(52) U.S. Cl. 361/56

(57) ABSTRACT

A circuit arrangement includes an ESD protection circuit for protecting a circuit node of the circuit arrangement against electrostatic discharge. The circuit arrangement includes a control circuit configured to deactivate the ESD protection circuit in response to a state signal representing a state of operation of the circuit arrangement.

### TECHNICAL FIELD

Embodiments of the invention relate to the field of ESD (electrostatic discharge) protection circuits to protect external pins of integrated circuits.

### BACKGROUND

A sudden and momentary current flow of an electrostatic discharge is a common reason for failure of integrated semiconductor circuits. In order to protect integrated circuits from damage or degradation some circuit nodes, especially those connected to external pins of the device package, are protected by an ESD protection circuit that clamps the voltage to a certain maximum value and provides a low resistance current path to sink the charge of an ESD event.

In CMOS devices ESD protection circuits are often implemented as gcNMOS (“gate coupled NMOS”) structures. A gcNMOS component comprises an n-channel MOS transistor having a drain coupled to the circuit node to be protected, a source coupled to ground potential and a gate coupled to the circuit node to be protected via a simple passive high pass. The high pass has to be designed such that, in case of an ESD event, the gate is sufficiently charged via the high pass to turn on the gcNMOS transistor and to sink the current of the electrostatic discharge.

ESD protection circuits comprising gcNMOS structures operate well if the voltage slopes of signals in the protected circuit are significantly smaller than the voltage slope occurring during an ESD event. However, in modern integrated circuits, for example, switching converters, voltage slopes during start-up and during normal operation are approximately as high as during ESD events. Thus, a gcNMOS ESD protection circuit would be also activated during normal operation and sinking current from the circuit node to be protected.

There is a need for improved ESD protection that is appropriate for modern, fast switching integrated circuits.

### SUMMARY OF THE INVENTION

One example of the invention relates to a circuit arrangement comprising an ESD protection circuit for protecting a circuit node of the circuit arrangement against electrostatic discharge. The circuit arrangement comprises: a control circuit configured to deactivate the ESD protection circuit in response to a state signal representing a state of operation of the circuit arrangement.

Another example of the invention relates to a circuit arrangement comprising an ESD protection circuit for protecting a circuit node of the circuit arrangement against electrostatic discharge. The ESD protection circuit comprises: a field effect transistor with a first load terminal, a second load terminal, and a gate terminal, where the first load terminal is connected to the circuit node and the second load terminal receives a reference potential; a capacitive element being connected between the first load terminal and the gate terminal; a resistive element being connected between the second load terminal and the gate terminal; a semiconductor switch being connected between the second load terminal and the gate terminal; and a control unit for controlling the semiconductor switch receiving a state signal and being configured to close the semiconductor switch delay time after a state signal has been received, where the state signal indicates normal operation of the circuit arrangement.

### BRIEF DESCRIPTION OF THE DRAWINGS

The invention can be better understood with reference to the following drawings and description. The components in the figures are not necessarily to scale, instead emphasis being placed upon illustrating the principles of the invention. Moreover, in the figures, like reference numerals designate corresponding parts. In the drawings:

FIG. 1 is a circuit diagram of a gate coupled NMOS structure for protecting an input against electrostatic discharges;

FIG. 2 illustrates the application of an integrated driver circuit for driving a half bridge of a buck converter;

FIG. 3 illustrates a novel ESD protection circuit used in the integrated driver circuit of FIG. 2 for protecting the bootstrap supply pin against ESD events; and

FIG. 4 illustrates a more detailed circuit to implement an embodiment of the circuit of FIG. 3.

### DETAILED DESCRIPTION OF ILLUSTRATIVE EMBODIMENTS

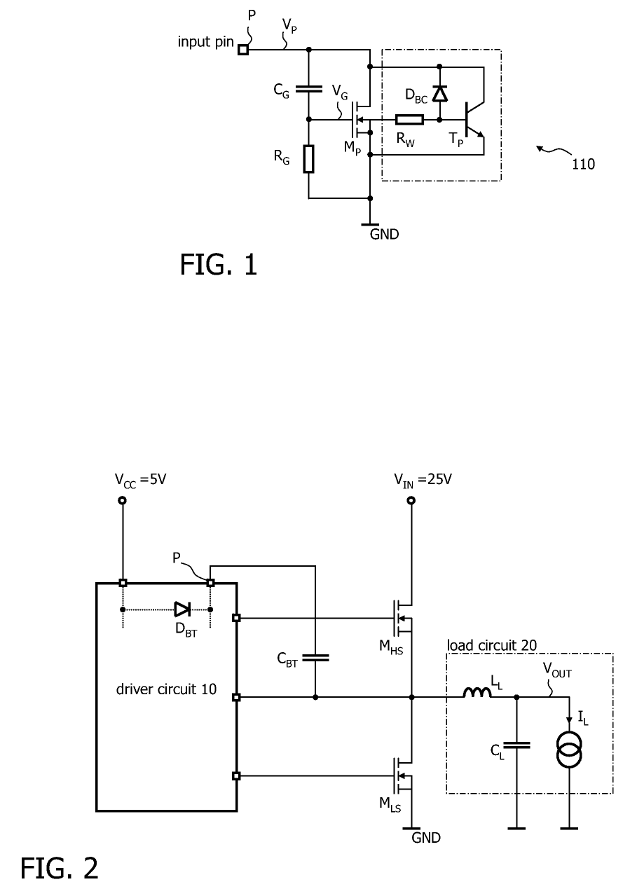

FIG. 1 illustrates an ESD protection circuit 110 comprising a gate coupled NMOS transistor M_{P}. The ESD protection circuit 110 is connected to a circuit node P for providing protection thereto against electrostatic discharges. The protected circuit node P may, for example, represent an external pin of a chip package. The NMOS transistor M_{P} comprises a drain, connected to the circuit node P, a source coupled to a reference potential, e.g., ground potential GND, and a gate connected to the circuit node P via a capacitor C_{G} and to the source via a resistor R_{G}. The capacitor C_{G} and the resistor R_{G} form a passive RC high pass coupling the gate and the circuit node P. The circuit elements drawn in the slash-dotted box are a parasitic bipolar transistor T_{P} always present in a MOSFET, a diode D_{BC}, representing the base-collector diode of the parasitic bipolar transistor T_{P} and a resistor R_{W} representing the base resistance of the parasitic bipolar transistor T_{P}. When the gate of the gcNMOS is charged and the ESD protection circuit starts to sink ESD current the parasitic bipolar transistor may be activated, too, in order to provide a low resistance current path from the protected circuit node P to ground potential GND.

When designing the gcNMOS ESD protection circuit 110 of FIG. 1 an important task is to choose appropriate values for the capacitor C_{G} and resistor R_{G}, i.e., to appropriately design the RC high pass coupling the protected circuit node P and the gate of the gcNMOS transistor M_{P}. Therefore the gate voltage V_{G} of the gcNMOS transistor M_{P} in case of an ESD event and during normal operation of the circuit has to be considered, whereby the gate voltage as a function of the voltage slope of the voltage V_{P} of circuit node P is important. Generally the Laplace transform V_{G}(s) of the gate voltage V_{G} can be calculated according to the following equation:

$${V}_{G} ( s ) = \frac{{sR}_{G} {C}_{G}}{1 + {sR}_{G} {C}_{G}} {V}_{P} ( s ) , \qquad ( 1 )$$

wherein V_{P}(s) is the Laplace transform of the voltage V_{P} of circuit node P and thus of the drain voltage of MOS transistor M_{P}. Assuming the voltage V_{P} ramps up over time t with a voltage slope α, that is

V_{P}=α·t, (2)

or, respectively,

$${V}_{P} ( s ) = \frac{α}{{s}^{2}} , \qquad ( 3 )$$

The Laplace transform V_{G}(s) of the gate voltage V_{G} yields:

$${V}_{G} ( s ) = \frac{{sR}_{G} {C}_{G}}{1 + {sR}_{G} {C}_{G}} \cdot \frac{α}{{s}^{2}} = \frac{α {R}_{G} {C}_{G}}{1 + {sR}_{G} {C}_{G}} \cdot \frac{1}{s} . \qquad ( 4 )$$

Transforming equation (4) back into the time domain results in:

V_{G}(t)=αR_{G}C_{G}(1−e^{-t/(R}^{_{G}}^{C}^{_{G}}⁾). (5)

In modern, fast switching circuits like, for example, buck converters (see FIG. 2) voltage slopes may be about 1.6 kV/μs or even more during normal operation. To assure that the MOSFET M_{P} remains switched off during normal operation the gate voltage V_{G} must not exceed the threshold voltage. Choosing V_{G}(10 ns)=0.5V may be an appropriate choice for keeping the MOSFET M_{P} off. Assuming a slope α of α=3 kV/μs and choosing a capacitor C_{G} of C_{G}=2 pF yields a resistor R_{G} of R_{G}=80Ω and a time constant R_{G} C_{G} of R_{G} C_{G}=160 ps (picoseconds).

The short time constant R_{G} C_{G}=160 ps of the high pass is necessary to keep the MOSFET M_{P} off during normal switching operation of the protected circuit node. However a typical ESD pulse may be as long as about 160 ns (nanoseconds). Consequently, with the above dimensioning the MOSFET would never switch on and sink current. In order to switch on in response to an ESD pulse the resistor R_{G} would have to be chosen as R_{G}=80 kΩ yielding a time constant R_{G} C_{G}=160 ns that is approximately equal to the duration of an ESD pulse. However, with such a time constant the ESD protection circuit would permanently sink current even during normal switching operation.

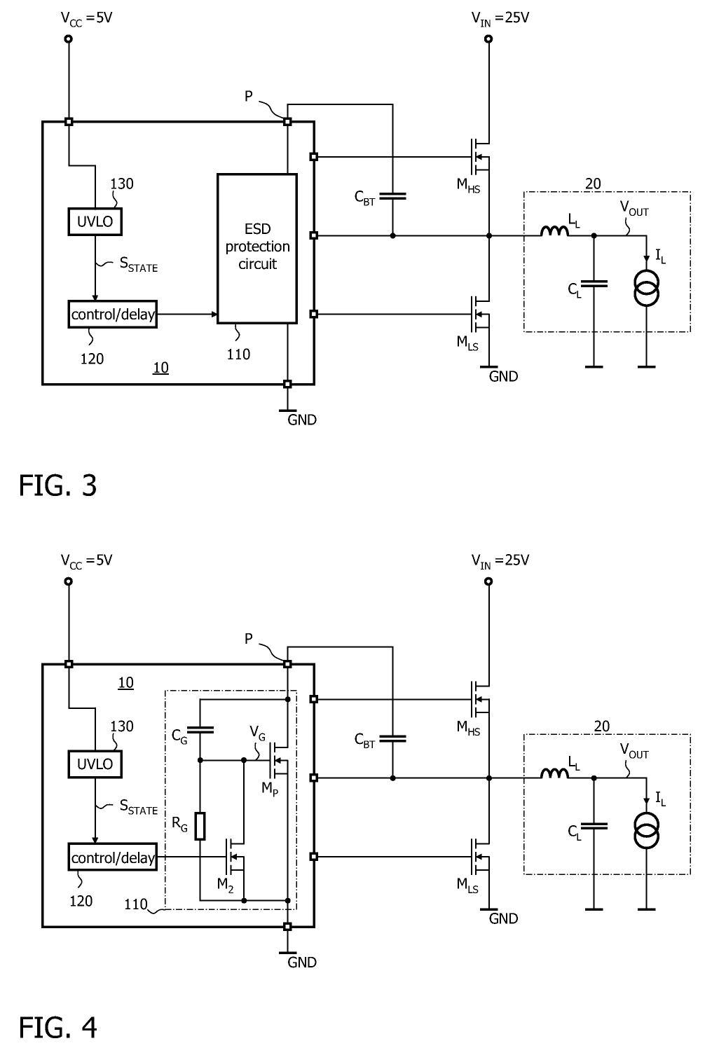

As a result of the above considerations it can be concluded that common gcNMOS ESD protection circuits can not be used to protect circuit nodes P whose potential V_{P} has rise times during normal switching operation similar to the rise time of a standard ESD pulse. As one example of the invention FIG. 3 illustrates the application of an improved ESD protection circuit 110 in a fast switching driver circuit for a buck converter.

The basic structure of a buck converter is illustrated in FIG. 2. A driver circuit 10 controls the switching state of a half bridge comprising a high-side semiconductor switch M_{HS} and a low-side semiconductor switch M_{LS}. Each semiconductor switch comprises a load path (e.g. drain-source path) and a control electrode (e.g., gate electrode). The load paths are connected in series between a first supply terminal providing a supply potential V_{IN} of about 25V and a second supply terminal providing a reference potential, e.g., ground potential. The common node of the semiconductor switches (also referred to as phase node) is connected to a load circuit, which in the case of a buck converter comprises a series circuit of an inductor L_{L} and a capacitor C_{L}, whereby the voltage across the capacitor C_{L} is the output voltage V_{OUT} of the buck converter. A current sink symbolizes the load current I_{L}. The driver circuit 10 is supplied with a further supply potential V_{CC} and generates driver signals that are supplied to the gate electrodes of the semiconductor switches M_{HS}, M_{LS}. For generating the driver signal for the high side semiconductor switch the driver circuit 10 the voltage signal of the phase node is fed back to the driver circuit. Furthermore a floating bootstrap supply voltage is provided at a bootstrap supply terminal of the driver circuit 10 by means of a bootstrap capacitor C_{BT} connected between the bootstrap supply terminal P and the phase node. When the phase node is close to ground potential GND the bootstrap capacitor is charged via a diode D_{BT} that is connected to the bootstrap capacitor and coupled to the further supply potential V_{CC}.

FIG. 3 illustrates as a first example of the invention a novel ESD protection circuit 110. In the example of FIG. 3 the ESD protection circuit 110 is applied to protect the bootstrap supply terminal of the driver circuit 10 of FIG. 2. However, this is not to be understood as limiting, in fact, the novel ESD protection circuit 110 may be used in many different switching applications and is especially useful for protecting supply pins of semiconductor chips, such as, for example, the bootstrap supply terminal P of the driver circuit of FIG. 2.

According to the present example the terminal P, i.e., the circuit node to be protected against electrostatic discharge, is coupled to ground potential GND via the ESD protection circuit 110 which, in case of an ESD event, sinks the current generated by the electrostatic discharge. The driver circuit 10 further comprises a control circuit 120 for the ESD protection circuit 110. The control circuit 120 is configured to deactivate the ESD protection circuit 110 in response to a state signal S_{STATE} representing a state of operation of the circuit arrangement 10. This state of operation may be, for example, “power down” and “normal operation”.

The ESD protection circuit 110 may be active during the power down mode of operation of the driver circuit and deactivated when the driver resumes normal operation. In another example the control circuit 120 may be configured to provide a delayed version of the state signal S_{STATE} to the ESD protection circuit 110. The ESD protection circuit 110 is then activated or deactivated dependent on the delayed state signal. The delay has to be at least as long as the pulse width of an ESD event. The delay may range from about 160 to about 500 nanoseconds, for example, about 320 to about 500 nanoseconds, in order to protect the circuit node 10 against an ESD event during the first 160 nanoseconds of operation, that is, during the start-up phase of the driver circuit 10. During the normal operation, after the start-up phase, the ESD protection circuit is deactivated since the power supply, that is the bootstrap capacitor C_{BT} in the present example, provides a low resistance current path (at least for AC signals) to ground potential.

The state signal S_{STATE}, i.e., the information whether the driver circuit 10 is in power down mode of operation or in normal mode of operation, may be obtained, for example, from an undervoltage lockout circuit 130 (UVLO). This signal is then delayed in the control circuit 120 as explained above. Alternatively, a chip enable signal (not shown) received from an external circuit may also be used as state signal S_{STATE} or the state signal S_{STATE} may be derived therefrom. However any other signal providing the desired information about the mode of operation of the driver circuit 10 may be used as a state signal S_{STATE} or may be used to derive the state signal S_{STATE}. A logical combination of several signals may also be adequate to derive the state signal S_{STATE}.

FIG. 4 illustrates the example of FIG. 3 in more detail. The ESD protection circuit 110 comprises a field effect transistor M_{P} with a first load terminal, a second load terminal, and a gate terminal. The first load terminal is connected to the circuit node P; the second load terminal is coupled to reference potential GND. The ESD protection circuit 110 further comprises a capacitive element C_{G} being connected between the first load terminal and the gate terminal, a resistive element R_{G} being connected between the second load terminal and the gate terminal. The field effect transistor M_{P}, the capacitive element C_{G}, and the resistive element R_{G} form a so-called gate coupled NMOS structure (gcNMOS). A further semiconductor switch M₂ is connected between the second load terminal and the gate terminal of the gcNMOS transistor M_{P}. The semiconductor switch M₂ may also be implemented as a NMOS transistor and thus allows for deactivating the gcNMOS transistor M_{P} and therefore the ESD protection functionality of the ESD protection circuit 110 as explained above with reference to FIG. 3.

Accordingly, the control unit 120 receiving the above-explained state signal S_{STATE} and controls the switching state of the semiconductor switch M₂. The control unit 120 is configured to close the semiconductor switch M₂ a delay time after a state signal S_{STATE} has been received. The state signal S_{STATE} thereby indicates normal operation of the circuit arrangement 10. As in the previous example of FIG. 3, in the present example the semiconductor switch M₂ is closed a short delay time after the undervoltage lockout circuit signals that the driver circuit is in a mode of normal operation. The ESD protection circuit is then not reactivated before the driver circuit 10 goes into power down mode.

Although various examples to realize the invention have been disclosed, it will be apparent to those skilled in the art that various changes and modifications can be made which will achieve some of the advantages of the invention without departing from the spirit and scope of the invention. It will be obvious to those reasonably skilled in the art that other components performing the same functions may be suitably substituted. Such modifications to the inventive concept are intended to be covered by the appended claims.

What is claimed is:

1. An integrated circuit comprising:
integrated circuitry coupled to a circuit node;
an ESD protection circuit for protecting the circuit node against electrostatic discharge; and
a control circuit coupled to the ESD protection circuit to deactivate the ESD protection circuit in response to a state signal representing a state of operation of the integrated circuitry.

2. The integrated circuit of claim 1, wherein the state signal is a logic signal having either a first logic level or a second logic level, and where the control circuit is configured to provide a delayed version of the state signal to the ESD protection circuit, the ESD protection circuit being activated or deactivated dependent on the delayed state signal.

3. The integrated circuit of claim 1, further comprising a circuit coupled to the control circuit to provide the state signal to the control circuit.

4. The integrated circuit of claim 3, wherein the circuit comprises an undervoltage lockout circuit, wherein a logic level of the state signal depends on whether or not the undervoltage lockout circuit detects an undervoltage.

5. The integrated circuit of claim 1, wherein the state signal comprises an external chip enable signal received by the integrated circuit.

6. The integrated circuit of claim 1, wherein the state signal comprises a logic combination of at least two external signals received by the integrated circuit.

7. The integrated circuit of claim 1, wherein the ESD protection circuit comprises a gate coupled NMOS transistor having a gate electrode and a load path that couples the circuit node and a reference potential node.

8. The integrated circuit of claim 7, wherein the ESD protection circuit further comprises a semiconductor switch coupling the reference potential node and the gate electrode of the gate coupled NMOS transistor, wherein the semiconductor switch receives the state signal from the control circuit at a control terminal.

9. An ESD protection circuit for protecting a circuit node of a circuit arrangement against electrostatic discharge, the ESD protection circuit comprising:
a field effect transistor with a first load terminal, a second load terminal, and a gate terminal, where the first load terminal is coupled to the circuit node and the second load terminal receives a reference potential node;
a capacitive element coupled between the first load terminal and the gate terminal;
a resistive element coupled between the second load terminal and the gate terminal;
a semiconductor switch coupled between the second load terminal and the gate terminal; and
a control unit coupled to the semiconductor switch, the control unit configured to close the semiconductor switch a delay time after a state signal has been received, wherein the state signal indicates normal operation of the circuit arrangement.

10. The ESD protection circuit of claim 9, further comprising an undervoltage lockout circuit to provide the state signal to the control circuit, wherein a logic level of the state signal depends on whether or not the undervoltage lockout circuit detects an undervoltage.

11. The ESD protection circuit of claim 9, wherein the state signal comprises an external chip enable signal received by the circuit arrangement.

12. The ESD protection circuit of claim 9, wherein the state signal comprises a logic combination of at least two external signals received by the circuit arrangement.

13. The ESD protection circuit of claim 9, where the field effect transistor comprises a gate coupled NMOS transistor.

14. A method for protecting a circuit node of a circuit arrangement against electrostatic discharge, the method comprising:
determining whether the circuit arrangement is in a first state of operation or a second state of operation;
activating an ESD protection circuit when the circuit arrangement is in the first state of operation; and
deactivating the ESD protection circuit when the circuit arrangement is in the second state of operation.

15. The method of claim 14, wherein the first state of operation comprises a power down mode and the second state of operation comprises a normal operation mode.

16. The method of claim 14, wherein the determining comprises generating a state signal having either a first logic level or a second logic level and delaying the state signal such that the ESD protection circuit is activated or deactivated dependent on the delayed state signal.

17. The method of claim 14, wherein determining whether the circuit arrangement is in the first state of operation or the second state of operation comprises evaluating a reference voltage.

18. The method of claim 17, wherein the determining comprises determining that the circuit arrangement is in a power down mode when the reference voltage falls below a predetermined voltage level.

19. The method of claim 18, wherein the first state of operation comprises a power down mode and the second state of operation comprises a normal operation mode.

20. The method of claim 14, wherein determining whether the circuit arrangement is in the first state of operation or the second state of operation comprises receiving an external chip enable signal.

21. The method of claim 14, wherein determining whether the circuit arrangement is in the first state of operation of the second state of operation comprises receiving at least two external signals and taking a logic combination of the at least two external signals.

22. The method of claim 14, wherein the ESD protection circuit comprises a gate coupled NMOS transistor having a gate electrode and a load path that connects a circuit node of the circuit arrangement and a reference potential.

23. The method of claim 22, where the ESD protection circuit further comprises a semiconductor switch coupling the reference potential and the gate electrode of the gate coupled NMOS transistor.
